(19) United States
(12) Patent Application Publication
(10) Pub. No.: US 2025/0245291 A1
(43) Pub. Date: Jul. 31, 2025

(54) CONFIGURING COMPLEX SYSTEMS USING INTERPOLATED PERFORMANCE FUNCTIONS AND POLYHARMONIC SPLINES

(71) Applicant: QUALCOMM Incorporated, San Diego, CA (US)

(72) Inventors: Vladimir APARIN, San Diego, CA (US); Aidin BASSAM, Oceanside, CA (US); Hitesh KHUNTI, San Diego, CA (US)

(21) Appl. No.: 18/429,148

(22) Filed: Jan. 31, 2024

(51) Int. Cl. G06F 17/17

(52) U.S. Cl. CPC G06F 17/175

(57) ABSTRACT

Certain aspects of the present disclosure provide techniques and apparatus for executing a workload on a computing device based on an approximation of a target function. An example method generally includes obtaining first performance data associated with a function to be approximated based on a set of inputs associated with a region of the function. An approximation of the function is generated based on fitting one or more polyharmonic spline-based interpolated performance functions to the first performance data. Based on the approximation of the function, a set of regions to estimate using subsequently obtained performance data is identified. Second performance data is obtained for each region in the identified set of regions based on the approximation of the function. When the approximation of the function meets a threshold performance level based on the second performance data, one or more actions are taken based on the approximation of the function.

### INTRODUCTION

Aspects of the present disclosure relate to configuring complex systems.

Complex systems, such as those involved in signal processing, training and executing inferencing operations using machine learning models, performing convolution operations in convolutional neural networks, computing attention in a transformer neural network, and the like, generally may be represented by complex mathematical functions defining an objective (e.g., a performance objective) based on various defined constraints, variables, and bounds. Because of the complexity of these functions that define these complex systems, identifying configuration parameters for these complex systems generally uses significant amounts of computational resources and may be impractical to perform under various resource constraints.

### BRIEF SUMMARY

Certain aspects of the present disclosure provide a method for configuring a complex software or hardware system based on an approximation of a target function associated with the complex hardware or software system. An example method generally includes obtaining first performance data associated with a function to be approximated based on a set of inputs associated with a region of the function. An approximation of the function is generated based on fitting one or more interpolated performance functions to the first performance data, the one or more interpolated performance functions comprising polyharmonic splines. Based on the approximation of the function, a set of regions to estimate using subsequently obtained performance data associated with the function is identified. Second performance data is obtained for each region in the identified set of regions based on the approximation of the function. When the approximation of the function meets a threshold performance level based on the second performance data, one or more actions are taken based on the approximation of the function.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 illustrates an example approximation of a target function based on an interpolated performance function comprising polyharmonic splines, according to aspects of the present disclosure.

FIG. 2 illustrates an example radio frequency system architecture which can be modeled using an approximation of a target function generated based on an interpolated performance function comprising polyharmonic splines, according to aspects of the present disclosure.

FIG. 3 illustrates an example artificial intelligence accelerator architecture which can be modeled using an approximation of a target function generated based on an interpolated performance function comprising polyharmonic splines, according to aspects of the present disclosure.

FIG. 4 illustrates example operations for configuring a complex system based on an approximation of a target function generated based on an interpolated performance function comprising polyharmonic splines, according to aspects of the present disclosure.

FIG. 5 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for configuring complex systems (e.g., hardware and/or software systems) based on approximation of a target function associated with these complex systems generated based on an interpolated performance function comprising polyharmonic splines.

Many hardware and software systems, such as radio frequency circuits, artificial intelligence accelerators, artificial intelligence models, semiconductor fabricating systems, and the like, can be represented by a target function that uses a number of inputs and operations defined for each of these inputs in order to generate an output. For a modeled digital and/or analog circuit, the inputs may correspond to various parameters of components in the circuit, and the output may correspond to various measurements such as a signal-to-noise ratio, power consumption measurement, or the like. For a machine learning model, the inputs may correspond to multidimensional data that is input into the model, and the output may correspond to an inference generated by the model from the input data, such as a prediction, a classification, or the like.

Generally, identifying parameters for these complex hardware and/or software systems may involve the execution of the functions associated with these systems many times to identify a set of parameters that achieves, or at least approaches, target performance metrics defined for the system. For example, identifying parameters for a system may involve the execution of the target function hundreds or thousands of times using different permutations of parameter values. Because each execution of a target function involves a computational expense (e.g., in terms of memory usage, processor cycles, time, etc.), it may be impractical to perform an exhaustive search to identify parameters for a complex system that achieves, or at least approaches, the target performance metrics defined for the system.

Because identifying parameters for the functions associated with complex hardware and/or software systems may be considered a constrained optimization problem, various optimization techniques can be used in an attempt to reduce the computational expense involved in configuring a complex system. For example Bayesian optimization techniques, in which the target function is considered a “black box” function such that surrogate models of an objective function and constraints associated with the target function are used to identify the parameters for a complex system. In doing so, measurements may be taken for various inputs into the function, and the selection of parameter values may be guided based on these measurements and the surrogate models in an iterative process. Generally, these surrogate models may be based on a linear combination of weighted nonlinear kernels, each of which may have kernel hyperparameters that define the behavior of the kernels.

For example, a kernel for a model approximated using Bayesian optimization techniques may be represented by the equation:

$$k ( {x}_{x} {\tilde{x}}_{m} ) = {σ}^{2} exp [ - {\sum }_{i = 1}^{n} \frac{{( {x}_{i} - {\tilde{x}}_{m , i} )}^{2}}{2 {l}_{i}^{2}} ]$$

where lᵢ represents a length scale for the model, x represents a query point in a multidimensional space, and \tilde{x} represents an observation in the multidimensional space. The model, in turn, may be represented by the equation:

$${μ}_{f} ( x ) = {\sum }_{m = 1}^{M} {w}_{m} k ( x , {\tilde{x}}_{m} )$$

where W=K(\tilde{X},\tilde{X})⁻¹\tilde{Y}. Generally larger values of lᵢ may be correlated with wider Gaussian distributions and a smoother model, while smaller values of lᵢ may be correlated with narrower Gaussian distributions and a less smooth model.

Because the nonlinear kernels of the surrogate models have hyperparameters themselves, the accuracy and convergence rate of the surrogate models may depend on the values of the hyperparameters (lᵢ, . . . , lₙ, σ) of the nonlinear kernels. Accurate identification of the values of hyperparameters for the nonlinear kernels associated with a surrogate model may be performed, for example, based on maximization of log marginal likelihood or the optimization of other metrics. Doing so may impose a first time overhead on the process of identifying parameters for a complex system. A second time overhead may be imposed on the process of identifying parameters for a complex system by the identification of a next point based on which the target function may be further optimized using an acquisition function (e.g., measuring metrics such as expected improvement, confidence bounds, entropy, etc.). These time overheads imposed by the identification of accurate hyperparameter values for the nonlinear kernels and the next location based on which a target function is to be optimized may restrict the number of dimensions over which a function can be optimized and may correspondingly limit the number of systems that can be optimized using Bayesian optimization techniques.

Aspects of the present disclosure provide techniques for configuring complex systems based on approximation of a target function associated with the complex hardware or software system. As discussed in further detail herein, an approximation of the target function may be performed based on an interpolated performance function which in turn may be based on one or more polyharmonic splines. A polyharmonic spline is a linear combination of a radial basis function and a polynomial term. By using polyharmonic splines in approximating a target function associated with a complex hardware or software system, aspects of the present disclosure allows for the efficient identification of parameters associated with the target function that optimizes the performance of the complex system defined by the target function. Because polyharmonic splines are not defined in terms of hyperparameters, unlike linear kernels used in Bayesian optimization of a function, aspects of the present disclosure may allow for the identification of parameters associated with the target function that optimizes the performance of the complex system using fewer computing resources than used by Bayesian optimization techniques. Further, aspects of the present disclosure may allow for improved accuracy in the identification of parameter values associated with the target function relative to Bayesian optimization techniques and may allow for accurate approximation of target functions with higher dimensionality than can be achieved using Bayesian optimization techniques.

### Example Approximation of a Target Function Using Interpolated Performance Functions Based on Polyharmonic Splines

To efficiently approximate a target function and identify a set of parameter values for the target function that achieves a target level of performance, aspects of the present disclosure provide for generating an approximation of the target function based on polyharmonic splines. Generally, a target function to be approximated based on polyharmonic splines may be represented by the equation:

$$y ( x ) = {\sum }_{m = 1}^{M} {u}_{m} a ( x , {\tilde{x}}_{m} ) + b ( x ) v$$

where M corresponds to a number of measurements made with respect to query points x, x=[x₁ . . . x_{D}] is a D-dimensional query point in a multidimensional space, \tilde{x}ₘ=[x_{m,1} . . . x_{m,D}] is the m^{th} D-dimensional measured point in the multidimensional space, b(x) corresponds to a Vandermonde matrix, u corresponds to the weights of one or more polyharmonic radial basis functions a(x,\tilde{x}ₘ), and v corresponds to the weights of the polynomial term b(x)v. The weights u of the polyharmonic radial basis functions may be represented by the expression:

u=[u₁ . . . u_{M}]^{T}

Similarly, the weights v of the polynomial term b(x) may be represented by the expression:

$$v = {[ {u}_{1} … {u}_{D + 1} ]}^{T}$$

A polyharmonic radial basis function a(x,\tilde{x}ₘ) generally is used to model a target function by passing through the measured points \tilde{x}ₘ. Generally, a polyharmonic radial basis function may be represented by the equation:

$$a ( x , {\tilde{x}}_{m} ) = \{ \begin{matrix}{r}^{k} , & k = 1 , 3 , 5 , … \\ {r}^{k} ln r , & k = 2 , 4 , 6 , …\end{matrix}$$

where k represents an order of the polyharmonic spline. r generally represents a Euclidean distance between the query points x and the measured points \tilde{x}ₘ in a D-dimensional space in which the target function lies.

To generate an approximation of the target function, the weights u and v may be determined so that the model interpolates M points (\tilde{x}ₘ,\tilde{y}ₘ) and such that the weights u associated with the polyharmonic radial basis function satisfies an orthogonality constraint defined by the function:

B(\tilde{X})^{T}u=0

The target model may thus be rewritten according to the expression:

$$y ( x ) = {\sum }_{m = 1}^{M} {u}_{m} a ( x , {\tilde{x}}_{m} ) + b ( x ) v = A ( x , \tilde{X} ) u + b ( x ) v = K ( x , \tilde{X} ) w$$

where K(x,\tilde{X})=[A(x,\tilde{X}) b(x)] and

$$w = [ \begin{matrix}u \\ v\end{matrix} ] .$$

By rewriting the target model as a matrix multiplication equation, the weights w (which may correspond to values of various parameters of a complex system to be optimized using the techniques discussed herein) may be written as a matrix using LU factorization in which the matrix w is decomposed into lower (L) and upper (U) triangular matrices or QR decomposition in which the matrix w is decomposed into an orthonormal matrix Q and an upper triangular matrix R. For example,

$$[ \begin{matrix}u \\ v\end{matrix} ]$$

may be represented by the equation:

$$[ \begin{matrix}u \\ v\end{matrix} ] = {[ \begin{matrix}A ( \tilde{X} , \tilde{X} ) & B ( \tilde{X} ) \\ {B ( \tilde{X} )}^{T} & 0\end{matrix} ]}^{- 1} [ \begin{matrix}\tilde{Y} \\ 0\end{matrix} ]$$

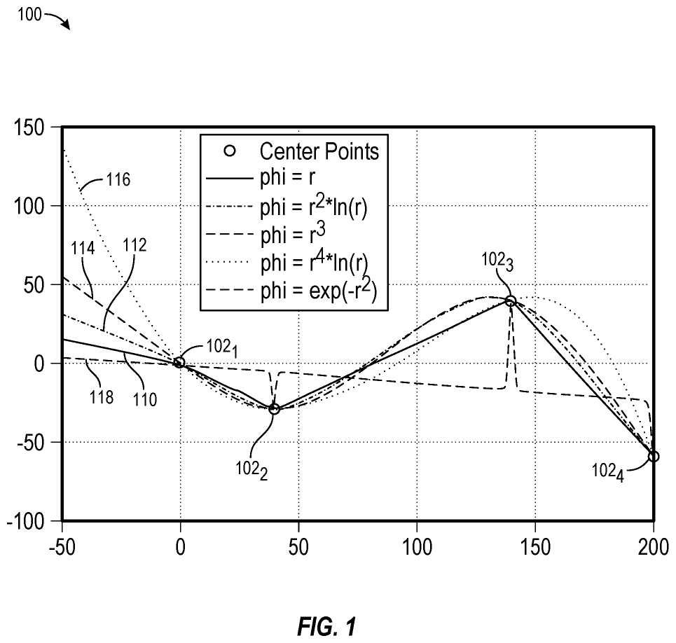

FIG. 1 illustrates an example 100 of approximating of a target function based on an interpolated performance function comprising polyharmonic splines, according to aspects of the present disclosure.

As illustrated, a plurality M of query points may be defined for measurement. These query points may specify values of a number of parameters based on which a performance target or other performance measurement for a target function may be measured. Based on the query points and measured points, the center points 102₁-102₄ (amongst others, not illustrated in FIG. 1, and collectively referred to herein as a center point 102) may be defined. As discussed, a center point 102 may represent the Euclidean distance between a query point and a corresponding measured point in a multidimensional space.

Based on the center points 102 generated from the query points and corresponding center points, an approximation of the target function is generated based on a polyharmonic spline such that the approximation intersects each of the center points 102. To do so, a radial basis function may be fit to the center points 102. As illustrated, different radial basis functions with different orders k may be used in defining a polyharmonic spline approximating the target function. A first-order polyharmonic spline (e.g., where k=1) may be illustrated by the spline 110 in FIG. 1 and represented by the equation a(x,\tilde{x}ₘ)=r; a second-order polyharmonic spline may be illustrated by the spline 112 and represented by the equation a(x,\tilde{x}ₘ)=r²×ln(r); a third-order polyharmonic spline may be illustrated by the spline 114 and represented by the equation a(x,\tilde{x}ₘ)=r³; a fourth-order polyharmonic spline may be illustrated by the spline 116 and represented by the equation a(x,\tilde{x}ₘ)=r⁴×ln(r); and an exponential spline may be illustrated by the spline 118 and represented by the equation a(x,\tilde{x}ₘ)=exp(−r²). While FIG. 1 illustrates an exponential spline and first through fourth order splines, it should be recognized that these splines are provided merely as illustration, and any order spline may be used as the polyharmonic radial basis function in a polyharmonic spline used to approximate the target function.

After the approximation of the target function is generated (e.g., based, at least on part, on one or more of the splines 110, 112, 114, 116, or 118, or others not illustrated in FIG. 1), a subsequent query point to use for further refining the approximation of the target function may be identified using an acquisition function which, as discussed, may model various metrics such as a probability of improving the approximation of the target function, an expected improvement to the target function, an upper or lower confidence bound associated with the performance of the target function, an entropy metric, or the like. Generally, the subsequent query point may be identified based on maximizing the acquisition function. To maximize the acquisition function, various techniques can be used. An exploration maximization technique, for example, may be used to identify regions for approximation based on the smallest difference between the output of the approximation of the target model at a given point and an uncertainty value for the model at that point. In another example, an exploitation maximization technique may be used to identify regions for approximation based on the smallest values of the approximation of the target model.

Using the approximation of the target function and the subsequent query point, the performance of the target function may be examined. If an exit condition is reached based on the performance of the approximation of the target function (e.g., that the performance of the approximation of the target function, given the parameters identified for one or more variables from the weights u and v), then the approximation of the target function may be used to configure the complex system represented by the target function. For example, the approximation of the target function may be used to configure one or more parameters of a hardware system, such as a radio frequency (RF) circuit or an artificial intelligence accelerator, amongst other hardware systems. In another example, the approximation of the target function may be used to execute training and/or inferencing operations using a machine learning model defined by the target function.

If, however, the performance of the approximation of the target function does not meet a performance threshold, the approximation of the target function may further be refined using the techniques discussed above.

### Example Systems Configurable Based on Approximation of a Target Function Using Interpolated Performance Functions Based on Polyharmonic Splines

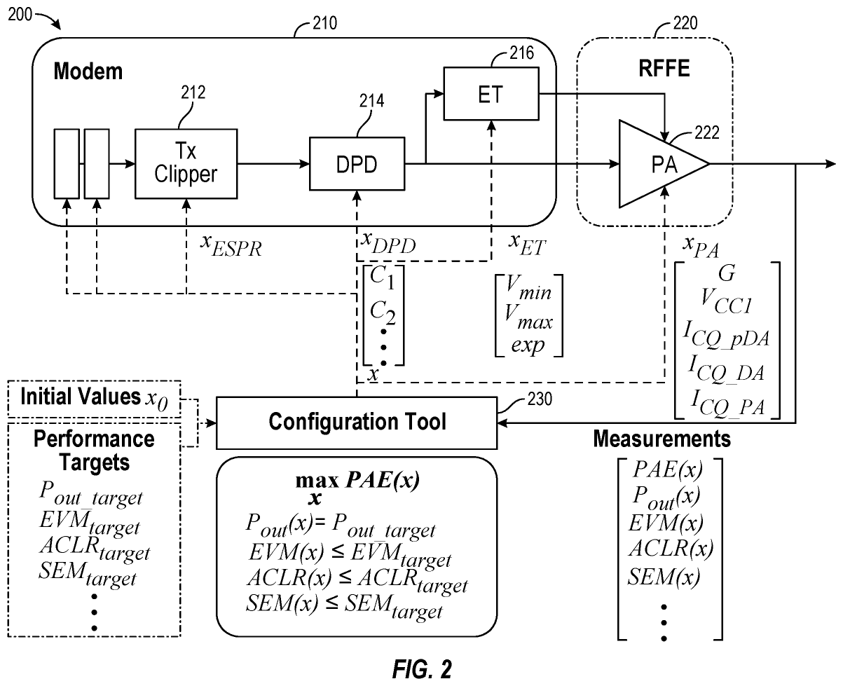

FIG. 2 illustrates an example radio frequency transceiver chain 200 which can be modeled using an approximation of a target function generated based on an interpolated performance function comprising polyharmonic splines, according to aspects of the present disclosure.

The radio frequency transceiver chain 200 generally includes a modem 210 and a radio frequency front end (RFFE) 220. The modem 210 may include at least a transmission clipper 212, a digital predistorter 214, and an envelope tracker 216, and the RFFE 220 may include at least a power amplifier 222. Generally, the transmission clipper 212 may determine, for example, an amount of power or gain that can be used on an input signal (e.g., a baseband signal, prior to conversion to a radio frequency signal) so as to minimize the likelihood of clipping the highest amplitude signal. The digital predistorter 214 may apply distortion to a digital signal to counter distortion introduced into a signal by the power amplifier 222 (and/or other components) of the RFFE 220. The envelope tracker 216 generally tracks the amplitude envelope of an RF signal generated by the modem 210 and RFFE 220 to track and adjust parameters of the power amplifier 222 so that the power amplifier 222 operates efficiently (e.g., meets various power usage and/or other power-related metrics).

In the radio frequency transceiver chain 200, a set of performance targets may be defined. For example, these performance targets may include an output power target P_{outTarget}, an error vector magnitude (EVM) target EM_{target}, an adjacent channel leakage ratio (ACLR) target ACLR_{target}, and a spectrum emission mask (SEM) target SEM_{target}. To generate parameters for the radio frequency transceiver chain 200 (e.g., (optional) parameters x_{ESPR} configuring the transmission clipper 212, parameters x_{DPD} configuring the digital predistorter 214, parameters x_{ET} configuring the envelope tracker 216, and/or parameters x_{PA} configuring the power amplifier 222, amongst others not illustrated in FIG. 2), a target function defining the behavior of the radio frequency transceiver chain 200 may be approximated using the techniques discussed above with respect to FIG. 1.

In some aspects, a configuration tool 230 may approximate a target function defining the behavior of the radio frequency transceiver chain 200 as a problem in which at least the digital predistorter 214, the envelope tracker 216, and the power amplifier 222 are jointly optimized. The optimization of the target function may, for example, seek to maximize power-added efficiency or other metrics measuring the power efficiency of the radio frequency transceiver chain 200, while complying with various power constraints. These constraints may include, for example, constraints related to the output power Pₒᵤₜ such that Pₒᵤₜ(x)=P_{outTarget}, constraints related to EVM such that EVM(x)≤EVM_{target}, constraints related to channel leakage such that ACLR(x)≤ACLR_{target}, constraints related to spectrum emissions masks such that SEM(x)≤SEM_{target}, and the like.

To configure the radio frequency transceiver chain 200, the configuration tool 230 can use one or more initial values x₀ based on which observations of the performance of the radio frequency transceiver chain 200 are generated. Based on differences between the initial values x₀ and the observed values x, at least the parameters x_{DPD}, x_{ET}, and x_{PA} may be modified according to an approximation of the target function defining the radio frequency transceiver chain 200 to generate a matrix of digital predistorter coefficients c, envelope tracking parameters defining minimum and maximum voltages Vₘᵢₙ and Vₘₐₓ, and power amplifier parameters associated with, for example, gain G, voltage V, and current I. Generally, until the performance of the radio frequency transceiver chain 200 complies with the constraints defined for the radio frequency transceiver chain 200, additional observations at defined query points in a multidimensional space may be obtained (e.g., using an acquisition function identifying a next query point to use in optimizing the performance of the radio frequency transceiver chain 200), and the parameters x_{DPD}, x_{ET}, and x_{PA}, amongst others, may be further refined.

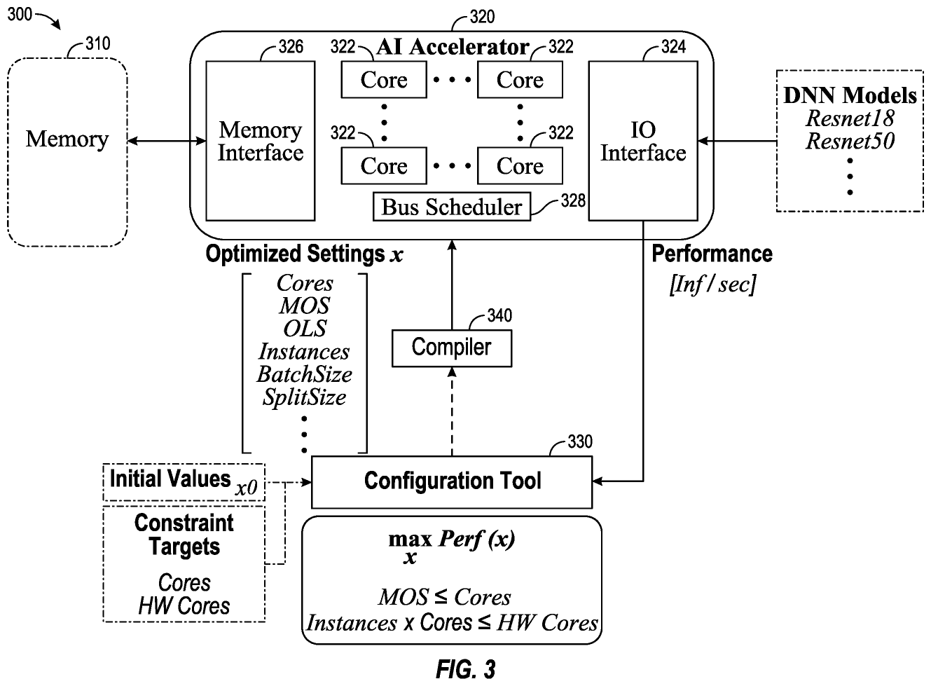

FIG. 3 illustrates an example artificial intelligence accelerator architecture 300 which can be modeled using an approximation of a target function generated based on an interpolated performance function comprising polyharmonic splines, according to aspects of the present disclosure.

The artificial intelligence accelerator architecture 300 generally includes a memory 310 in which data used by the accelerator 320 is stored or written and an accelerator 3200 including one or more processing cores 322, an input/output interface 324 which receives models to execute on the accelerator 320, a memory interface 326 for writing to and reading from the memory 310, and a bus scheduler 328.

In the artificial intelligence accelerator architecture 300, a performance target (e.g., measured in terms of inferences performed over a defined period of time) may be maximized, according to constraints related to the number of cores present on the accelerator 320. To configure the artificial intelligence accelerator architecture 300, a configuration tool 330 can use an initial set of values x₀ identifying, for example, a number of cores on which inferencing operations can be executed, a number of instances of models executed on the accelerator 320, a batch size identifying a number of samples to use prior to updating model parameters, a split size identifying a number of portions into which training data used to train and validate the machine learning model is to be split, amongst others. The values x₀ may be used to generate an observed set of values \tilde{x} and generate an approximation of a target function defining the functionality of the artificial intelligence accelerator architecture 300.

Subsequently, the settings x may be updated based on weights identified for a radial basis function and a polynomial in a polyharmonic spline fit to the observations \tilde{x}. Generally, until the performance of the artificial intelligence accelerator architecture 300 complies with the constraints defined for the artificial intelligence accelerator architecture 300, additional observations at defined query points in a multidimensional space may be obtained (e.g., using an acquisition function identifying a next query point to use in optimizing the performance of the artificial intelligence accelerator architecture 300), and the parameters x may be further refined. When the performance of the artificial intelligence accelerator architecture 300 meets the defined objective, a machine learning model may be compiled by the compiler 340 using the settings x.

### Example Operations for Configuring Systems Based on Approximation of a Target Function Using Interpolated Performance Functions Based on Polyharmonic Splines

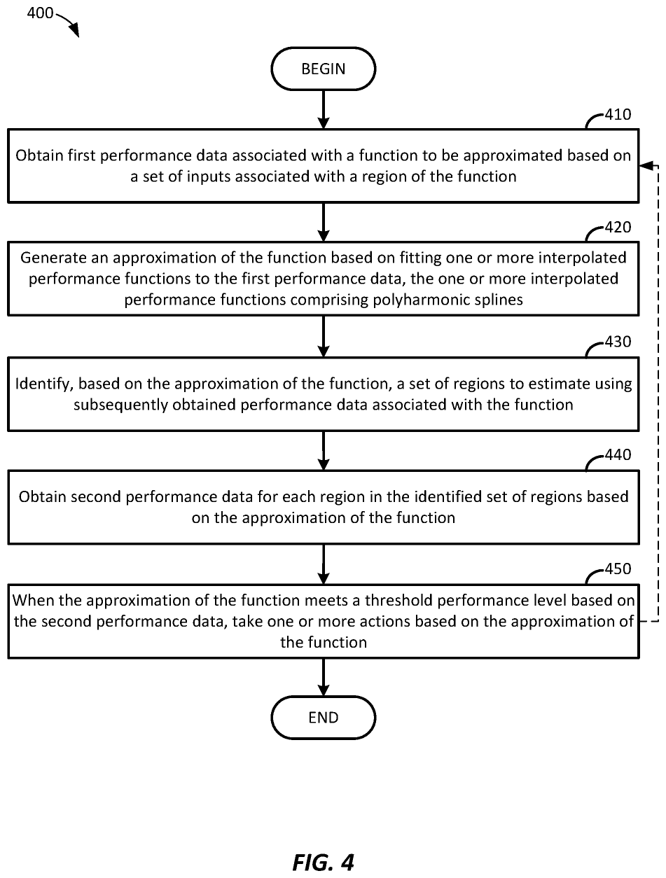

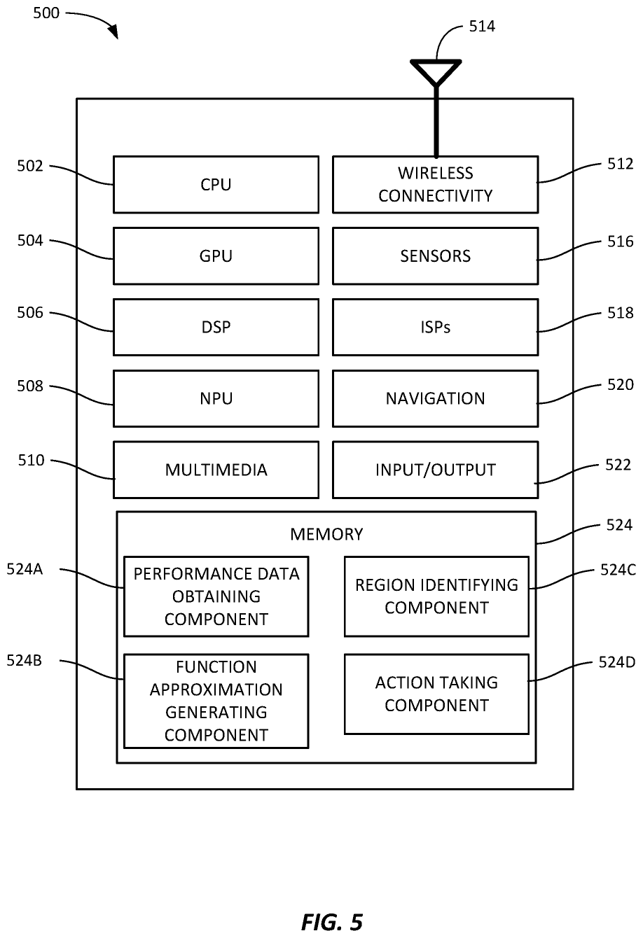

FIG. 4 shows an example of operations 400 which may be performed to efficiently configure a complex system based on an approximation of a target function generated based on an interpolated performance function comprising polyharmonic splines, according to aspects of the present disclosure. The operations 400 may, in some aspects, implement the techniques discussed above with respect to FIG. 1 for efficiently approximating a target function (e.g., a target function defining radio frequency system architecture as illustrated in FIG. 2, a target function defining an artificial intelligence accelerator as illustrated in FIG. 3, or the like) and configuring a system based on the approximation of the target function. The operations 400 may be performed by a computing device including one or more processors, such as a processing system 500 illustrated in FIG. 5.

As illustrated, the operations 400 begin at block 410 with obtaining first performance data associated with a function to be approximated based on a set of inputs associated with a region of the function.

In some aspects, the first performance data is obtained based on a set of M obtained points for a corresponding set of query points.

At block 420, the operations 400 proceed with generating an approximation of the function based on fitting one or more interpolated performance functions to the first performance data, the one or more interpolated performance functions comprising polyharmonic splines.

In some aspects, generating the approximation of the function comprises generating first weights associated with a polyharmonic radial basis function and second weights associated with a polynomial term in the one or more interpolated performance functions. The polyharmonic radial basis function may generate an output based on a difference between a query point and a measured point in a multidimensional space.

At block 430, the operations 400 proceed with identifying, based on the approximation of the function, a set of regions to estimate using subsequently obtained performance data associated with the function.

In some aspects, the set of regions may be identified further based on an acquisition function measuring a degree of uncertainty associated with the polyharmonic splines for the first performance data.

At block 440, the operations 400 proceed with obtaining second performance data for each region in the identified set of regions based on the approximation of the function.

At block 450, the operations 400 proceed with, when the approximation of the function meets a threshold performance level based on the second performance data, taking one or more actions based on the approximation of the function.

In some aspects, the operations 400 further include, when the approximation of the function does not meet the threshold level based on the second performance data, the operations 400 may return to block 410. In doing so, the approximation of the function may be updated based on fitting the one or more interpolated performance functions to the second performance data. Based on the acquisition function and the updated approximation of the function, a subsequent set of regions to estimate is identified. Third performance data is obtained for each region in the identified subsequent set of regions based on the updated approximation of the function. Based on determining that the updated approximation of the function meets the threshold performance level based on the third performance data, the one or more actions may be taken based on the updated approximation of the function.

In some aspects, the polyharmonic splines omit estimation of kernel hyperparameters in generating the approximation of the function.

In some aspects, the function defines parameters associated with a processor on which a machine learning model is to be executed. The one or more actions may include configuring the parameters associated with the processor on which the machine learning model is to be executed based on the approximation of the function.

In some aspects, the function defines parameters associated with a radio frequency (RF) transceiver chain. The one or more actions may include configuring the parameters associated with the RF transceiver chain based on the approximation of the function.

In some aspects, the function to be approximated is approximated as a constrained optimization problem. In some aspects, the function to be approximates is approximated as a Bayesian optimization problem.

Note that FIG. 4 is just one example of a method, and other methods including fewer, additional, or alternative steps are possible consistent with this disclosure.

### Example Processing Systems for Configuring Systems Based on Approximation of a Target Function Using Interpolated Performance Functions Based on Polyharmonic Splines

FIG. 5 depicts an example processing system 500 that may be configured to perform aspects of the techniques described herein for computationally efficient approximation and solving of a target function (e.g., target functions defining a radio frequency transceiver chain 200 illustrated in FIG. 2, an artificial intelligence accelerator architecture 300 illustrated in FIG. 3, or the like), including, for example, the operations 400 illustrated in FIG. 4.

The processing system 500 includes a central processing unit (CPU) 502, which in some examples may be a multi-core CPU. Instructions executed at the CPU 502 may be loaded, for example, from a program memory associated with the CPU 502 or may be loaded from a memory 524.

The processing system 500 also includes additional processing components tailored to specific functions, such as a graphics processing unit (GPU) 504, a digital signal processor (DSP) 506, a neural processing unit (NPU) 508, a multimedia processing unit 510, and a wireless connectivity component 512.

An NPU, such as the NPU 508, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), or vision processing unit (VPU).

NPUs, such as the NPU 508, may be configured to accelerate the performance of common machine learning tasks, such as image classification, sound classification, and various other predictive models. In some examples, a plurality of NPUs may be instantiated on a single chip, such as a system on a chip (SoC), while in other examples NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece through an already trained model to generate a model output (e.g., an inference).

In some implementations, the NPU 508 is a part of one or more of the CPU 502, the GPU 504, and/or the DSP 506.

In some examples, the wireless connectivity component 512 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and other wireless data transmission standards. The wireless connectivity component 512 is further coupled to one or more antennas 514.

The processing system 500 may also include one or more sensor processing units 516 associated with any manner of sensor, one or more image signal processors (ISPs) 518 associated with any manner of image sensor, and/or a navigation processor 520, which may include satellite-based positioning system components (e.g., GPS or GLONASS) as well as inertial positioning system components.

The processing system 500 may also include one or more input and/or output devices 522, such as screens, touch-sensitive surfaces (including touch-sensitive displays), physical buttons, speakers, microphones, and the like.

In some examples, one or more of the processors of processing system 500 may be based on an ARM or RISC-V instruction set.

The processing system 500 also includes the memory 524, which is representative of one or more static and/or dynamic memories, such as a dynamic random access memory, a flash-based static memory, and the like. In this example, the memory 524 includes computer-executable components/units, which may be executed by one or more of the aforementioned processors of the processing system 500.

In this example, the memory 524 includes a performance data obtaining component 524A, a function approximation generating component 524B, a region identifying component 524C, and an action taking component 524D. The depicted components/units, and others not depicted, may be configured to perform various aspects of the methods described herein.

The processing system 500 is just one example and may generally perform operations (e.g., of a server and/or clients) described herein. However, in other aspects, certain aspects may be omitted. For example, a server may omit certain features that may be regularly found in a mobile device, such as the multimedia processing unit 510, the wireless connectivity component 512, the antenna 514, the sensor processing units 516, the ISPs 518, and the navigation processor 520.

Generally, the processing system 500 and/or components thereof may be configured to perform the methods described herein.

### Example Clauses

Implementation examples are described in the following numbered clauses:

Clause 1: A processor-implemented method, comprising: obtaining first performance data associated with a function to be approximated based on a set of inputs associated with a region of the function; generating an approximation of the function based on fitting one or more interpolated performance functions to the first performance data, the one or more interpolated performance functions comprising polyharmonic splines; identifying, based on the approximation of the function, a set of regions to estimate using subsequently obtained performance data associated with the function; obtaining second performance data for each region in the identified set of regions based on the approximation of the function; and when the approximation of the function meets a threshold performance level based on the second performance data, taking one or more actions based on the approximation of the function.

Clause 2: The method of Clause 1, further comprising, when the approximation of the function does not meet the threshold level based on the second performance data: updating the approximation of the function based on fitting the one or more interpolated performance functions to the second performance data; identifying, based on an acquisition function and the updated approximation of the function, a subsequent set of regions to estimate; obtaining third performance data for each region in the identified subsequent set of regions based on the updated approximation of the function; and based on determining that the updated approximation of the function meets the threshold performance level based on the third performance data, taking the one or more actions based on the updated approximation of the function.

Clause 3: The method of Clause 1 or 2, wherein the first performance data is obtained based on a set of M obtained points for a corresponding set of query points.

Clause 4: The method of any of Clauses 1 through 3, wherein generating the approximation of the function comprises generating first weights associated with a polyharmonic radial basis function and second weights associated with a polynomial term in the one or more interpolated performance functions.

Clause 5: The method of Clause 4, wherein the polyharmonic radial basis function generates an output based on a difference between a query point and a measured point in a multidimensional space.

Clause 6: The method of any of Clauses 1 through 5, wherein the set of regions is identified further based on an acquisition function measuring a degree of uncertainty associated with the polyharmonic splines for the first performance data.

Clause 7: The method of any of Clauses 1 through 6, wherein the polyharmonic splines omit estimation of kernel hyperparameters in generating the approximation of the function.

Clause 8: The method of any of Clauses 1 through 7, wherein the function defines parameters associated with a processor on which a machine learning model is to be executed.

Clause 9: The method of Clause 8, wherein the one or more actions comprise configuring the parameters associated with the processor on which the machine learning model is to be executed based on the approximation of the function.

Clause 10: The method of any of Clauses 1 through 9, wherein the function defines parameters associated with a radio frequency (RF) transceiver chain.

Clause 11: The method of Clause 10, wherein the one or more actions comprise configuring the parameters associated with the RF transceiver chain based on the approximation of the function.

Clause 12: The method of any of Clauses 1 through 11, wherein the function to be approximated is approximated as a constrained optimization problem.

Clause 13: The processing system of any of Clauses 1 through 12, wherein the function to be approximated is approximated as a Bayesian optimization problem.

Clause 14: A system, comprising: a memory having executable instructions stored thereon; and a processor configured to execute the executable instructions in order to cause the system to perform the operations of any of Clauses 1 through 13.

Clause 15: A system comprising means for performing the operations of any of Clauses 1 through 13.

Clause 16: A computer-readable medium having instructions stored thereon which, when executed by one or more processors of a processing system, cause the processing system to perform the operations of any of Clauses 1 through 13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising:
at least one memory having executable instructions stored thereon; and
one or more processors configured to execute the executable instructions to cause the processing system to:
obtain first performance data associated with a function to be approximated based on a set of inputs associated with a region of the function;
generate an approximation of the function based on fitting one or more interpolated performance functions to the first performance data, the one or more interpolated performance functions comprising polyharmonic splines;
identify, based on the approximation of the function, a set of regions to estimate using subsequently obtained performance data associated with the function;
obtain second performance data for each region in the identified set of regions based on the approximation of the function; and
when the approximation of the function meets a threshold performance level based on the second performance data, take one or more actions based on the approximation of the function.

2. The processing system of claim 1, wherein the one or more processors are configured to cause the processing system to, when the approximation of the function does not meet the threshold performance level based on the second performance data:
update the approximation of the function based on fitting the one or more interpolated performance functions to the second performance data;
identify, based on an acquisition function and the updated approximation of the function, a subsequent set of regions to estimate;
obtain third performance data for each region in the identified subsequent set of regions based on the updated approximation of the function; and
based on a determination that the updated approximation of the function meets the threshold performance level based on the third performance data, take the one or more actions based on the updated approximation of the function.

3. The processing system of claim 1, wherein the first performance data is obtained based on a set of M obtained points for a corresponding set of query points.

4. The processing system of claim 1, wherein to generate the approximation of the function, the one or more processors are configured to cause the processing system to generate first weights associated with a polyharmonic radial basis function and second weights associated with a polynomial term in the one or more interpolated performance functions.

5. The processing system of claim 4, wherein the polyharmonic radial basis function generates an output based on a difference between a query point and a measured point in a multidimensional space.

6. The processing system of claim 1, wherein the set of regions is identified further based on an acquisition function measuring a degree of uncertainty associated with the polyharmonic splines for the first performance data.

7. The processing system of claim 1, wherein the polyharmonic splines omit estimation of kernel hyperparameters in generating the approximation of the function.

8. The processing system of claim 1, wherein the function defines parameters associated with a processor on which a machine learning model is to be executed.

9. The processing system of claim 8, wherein to take the one or more actions, the one or more processors are configured to cause the processing system to configure the parameters associated with the processor on which the machine learning model is to be executed based on the approximation of the function.

10. The processing system of claim 1, wherein the function defines parameters associated with a radio frequency (RF) transceiver chain.

11. The processing system of claim 10, wherein to take the one or more actions, the one or more processors are configured to cause the processing system to configure the parameters associated with the RF transceiver chain based on the approximation of the function.

12. The processing system of claim 1, wherein the function to be approximated is approximated as a constrained optimization problem.

13. The processing system of claim 1, wherein the function to be approximated is approximated as a Bayesian optimization problem.

14. A processor-implemented method, comprising:
obtaining first performance data associated with a function to be approximated based on a set of inputs associated with a region of the function;
generating an approximation of the function based on fitting one or more interpolated performance functions to the first performance data, the one or more interpolated performance functions comprising polyharmonic splines;
identifying, based on the approximation of the function, a set of regions to estimate using subsequently obtained performance data associated with the function;
obtaining second performance data for each region in the identified set of regions based on the approximation of the function; and
when the approximation of the function meets a threshold performance level based on the second performance data, taking one or more actions based on the approximation of the function.

15. The method of claim 13, further comprising, when the approximation of the function does not meet the threshold performance level based on the second performance data:
updating the approximation of the function based on fitting the one or more interpolated performance functions to the second performance data;
identifying, based on an acquisition function and the updated approximation of the function, a subsequent set of regions to estimate;
obtaining third performance data for each region in the identified subsequent set of regions based on the updated approximation of the function; and
based on determining that the updated approximation of the function meets the threshold performance level based on the third performance data, taking the one or more actions based on the updated approximation of the function.

16. The method of claim 13, wherein the first performance data is obtained based on a set of M obtained points for a corresponding set of query points.

17. The method of claim 13, wherein:
generating the approximation of the function comprises generating first weights associated with a polyharmonic radial basis function and second weights associated with a polynomial term in the one or more interpolated performance functions, and
the polyharmonic radial basis function generates an output based on a difference between a query point and a measured point in a multidimensional space.

18. The method of claim 13, wherein the set of regions is identified further based on an acquisition function measuring a degree of uncertainty associated with the polyharmonic splines for the first performance data.

19. The method of claim 13, wherein the function defines one or more of parameters associated with a processor on which a machine learning model is to be executed or parameters associated with a radio frequency (RF) transceiver chain.

20. A processing system, comprising:
means for obtaining first performance data associated with a function to be approximated based on a set of inputs associated with a region of the function;
means for generating an approximation of the function based on fitting one or more interpolated performance functions to the first performance data, the one or more interpolated performance functions comprising polyharmonic splines;
means for identifying, based on the approximation of the function, a set of regions to estimate using subsequently obtained performance data associated with the function;
means for obtaining second performance data for each region in the identified set of regions based on the approximation of the function; and
means for taking, when the approximation of the function meets a threshold performance level based on the second performance data, one or more actions based on the approximation of the function.
